(19) United States
(12) Patent Application Publication
(10) Pub. No.: US 2013/0343698 A1
(43) Pub. Date: Dec. 26, 2013

(54) IR REFLOWABLE OPTICAL TRANSCEIVER

(71) Applicant: Jamyuen Ko, San Jose, CA (US)

(72) Inventor: Jamyuen Ko, San Jose, CA (US)

(21) Appl. No.: 13/976,664

(22) PCT Filed: Jan. 13, 2012
(86) PCT No.: PCT/US2012/021284

§ 371 Date: Jun. 27, 2013

(51) Int. Cl. G02B 6/12

(52) U.S. Cl. CPC G02B 6/12
USPC 385/14

(57) ABSTRACT

An optical connector includes a plastic lens body having a CTE sufficient to withstand solder reflow. The optical connector includes a substrate to electrically connect to a circuit, and the optical-electrical conversion can occur on the connector. The substrate can include a laser diode and a photodetector to convert optical and electrical signals. The laser diode and photodetector can be controlled by a controller on the substrate.

### FIELD

Embodiments of the invention are generally related to optical interconnections, and more particularly to an optical transceiver circuit.

### COPYRIGHT NOTICE/PERMISSION

Portions of the disclosure of this patent document may contain material that is subject to copyright protection. The copyright owner has no objection to the reproduction by anyone of the patent document or the patent disclosure as it appears in the Patent and Trademark Office patent file or records, but otherwise reserves all copyright rights whatsoever. The copyright notice applies to all data as described below, and in the accompanying drawings hereto, as well as to any software described below: Copyright ©2011, Intel Corporation, All Rights Reserved.

### BACKGROUND

The demand for computing devices continues to rise, even as the demand for computing devices to achieve higher performance also rises. However, conventional electrical I/O (input/output) signaling is not expected to keep pace with the demand for performance increases, especially for future high performance computing expectations. Currently, I/O signals are sent electrically to and from the processor through the board and out to peripheral devices. Electrical signals must pass through solder joints, traces, cables, and other electrical conductors. Electrical I/O signal rates are limited by the electrical characteristics of the electrical connectors.

While the use of optical interconnections finds increasing use in computing devices, currently the components used for optical signaling require special processing that increases the cost and complexity of system manufacturing. In particular, plastic lenses used for optical signaling cannot withstand the environment of solder reflow processing. Such processing warps or otherwise deforms the lenses, which negatively affects alignment, focusing, and the transfer of optical signals.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of an embodiment of an optical connector disposed on a substrate.

FIG. 2 is a block diagram of an embodiment of a substrate for an optical transceiver.

FIG. 3 is a block diagram of an embodiment of an optical lens body disposed on a substrate over a laser diode and photodetector.

FIG. 4 is a block diagram of an embodiment of an optical transceiver interfacing with an optical jumper connector.

FIGS. 5A-5B illustrate block diagrams of different perspectives of an embodiment of an optical connector that secures with a jumper connector via a latch.

FIG. 6 is a block diagram of an embodiment of a computing system in which an optical connector can be used.

FIG. 7 is a block diagram of an embodiment of a mobile device in which an optical connector can be used.

Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

### DETAILED DESCRIPTION

As described herein, an optical connector includes a plastic lens body that can withstand solder reflow processing. The plastic lens body has a coefficient of thermal expansion (CTE) that allows it to maintain its shape through the environment of an IR (infrared) reflow solder process. Thus, the plastic lens can be disposed on a mountable substrate, allowing an optical transceiver to be created in a surface-mount component. The optical connector includes the substrate to electrically connect to a circuit, and the optical-electrical conversion can occur on the connector. The substrate can include a laser diode and a photodetector to convert optical and electrical signals. The laser diode and photodetector can be controlled by a controller on the substrate. Thus, a mountable connector (e.g., mountable via SMT (surface mount technology)) can include electrical-optical conversion capability with a plastic, moldable lens body that can withstand the reflow process.

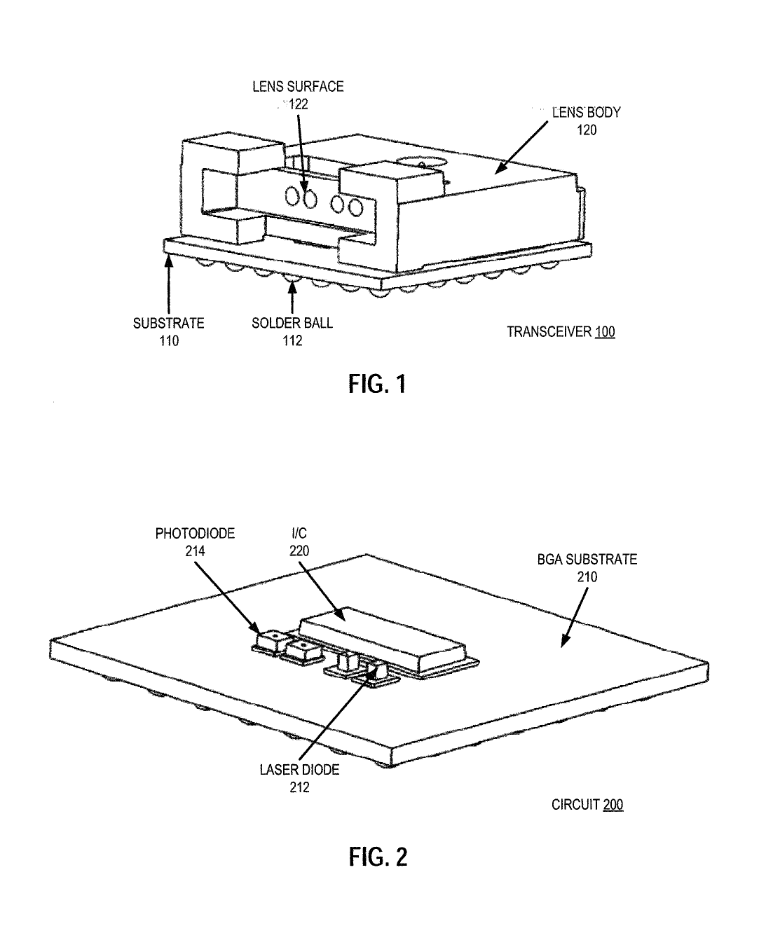

FIG. 1 is a block diagram of an embodiment of an optical connector disposed on a substrate. Transceiver 100 is an optical transceiver that can go through an IR reflow SMT process. Transceiver 100 includes lens body 120 mounted on substrate 110. Lens body 120 is made of a plastic that can withstand the environment of solder reflow.

Lens body 120 includes lens surface 122, which includes one or more lenses through which optical signals are exchanged. The optical signals have a line of propagation or a direction of propagation, which is orthogonal to lens surface 122. In one embodiment, lens body 120 includes a total-internal-reflection (TIR) surface or mirror that redirects light at approximately a right angle between lens surface 120 and substrate 110. It will be understood that a different angle other than a right angle could be used.

In one embodiment, the right-angle redirection is a 90 degree redirection from horizontal to vertical for received light, and vertical to horizontal for transmitted light. In one embodiment, the redirection occurs in free space within lens body 120, and does not require a specific waveguide in the connector. Alternatively, specific waveguides can be formed in lens body 120. The redirection through free space can occur when lens body 120 is made of a plastic that allows light to propagate through it with little to no optical loss. Such a material is optically transparent at the wavelength(s) of interest.

By mounting lens body 120 onto substrate 110, the entire lens connector can be processed with available high-precision assembly equipment used to place and mount components. Thus, special assembly processes can be avoided when using transceiver 100. In one embodiment, substrate 110 is mountable via a solder joint or solder connection, as shown by solder ball 112. In one embodiment, substrate 110 is a BGA (ball grid array) substrate, or an LGA (land-grid array) substrate. Alternatively, pins or pads or through-hole connections can be used.

Transceiver 100 connects electrically through substrate 110 onto a circuit. In one embodiment, the circuit is part of a printed circuit board (PCB). The PCB can be, for example, an FR4 (flame retardant 4) substrate. In one embodiment, substrate 110 can be mounted onto another integrated circuit or another substrate.

FIG. 2 is a block diagram of an embodiment of a substrate for an optical transceiver. Circuit 200 can be one example of a substrate circuit on which a lens body is mounted, such as lens body 120 of FIG. 1. In one embodiment, circuit 200 includes BGA substrate 210, which could alternatively be a substrate that connects via another technology (e.g., LGA, pins, pads).

An optical transceiver can convey or convert electrical signals to optical signals and vice versa. In one embodiment, circuit 200 includes one or more laser diodes 212 mounted on substrate 210 to generate an optical signal for transmission from an electrical signal. In one embodiment, circuit 200 includes photodiode (also referred to as a photodetector) 214 to generate an electrical signal from a received optical signal. It is also possible to have a substrate with only laser diodes or only photodetectors. Two separate substrates could be used, one for receive and one for transmit.

In one embodiment, integrated circuit (I/C) 220 is mounted to substrate 210. I/C 220 can control the transmission and/or receipt of optical signals through laser diode 212, photodiode 214, or both. In one embodiment, I/C 220 provides timing and/or signaling control of the electrical-optical conversion components. A controller could be placed on the circuit to which circuit 200 will be mounted, instead of the on substrate 210. A plastic lens body is mounted on substrate 210. With the addition of an IR-reflowable plastic lens body, circuit 200 is an optical transceiver that is capable of going through standard SMT processing.

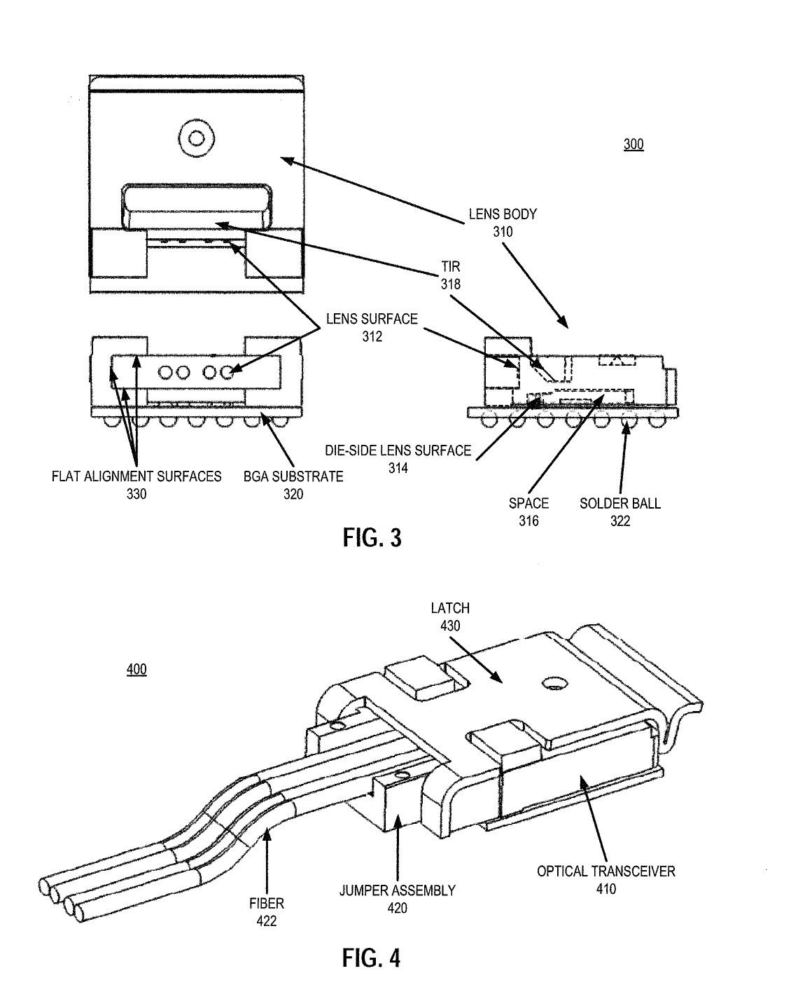

FIG. 3 is a block diagram of an embodiment of an optical lens body disposed on a substrate over a laser diode and photodetector. Circuit 300 represents an optical transceiver in accordance with any embodiment described herein. The circuit is illustrated from three different perspectives: a top view, a front view directly under the top view, and a side view to the side of the front view.

In the top view, TIR 318 is seen extending back behind lens surface 312, with reference to a direction of propagation of the optical signals through the lenses. In the side view, TIR 318 is seen angling down toward the bottom of lens body 310. The angle causes light to be redirected from the bottom of lens body 318 (the part that is closest to substrate 320) to lens surface 312, and vice versa.

Lens body 310 is formed of a plastic having a CTE sufficient to withstand dimensional deviation or dimensional distortion during solder reflow processing. In one embodiment, lens body 310 is molded. TIR surface 318 can be formed simply by the molding process at an angle, and with an air gap behind it (relative to the direction of light propagation) to cause a difference in refractive index. The difference in refractive index can cause optical redirection with little to no loss. Alternatively, TIR 318 can be coated on the external surface with a metal (forming a mirror) to cause the redirection of light. Thus, while TIR typically refers to a reflective surface caused by refractive index differences, a mirror could alternatively be used.

The redirection of light can be at approximately a right angle (as shown), or it can be at some other angle. In one embodiment, substrate 320 includes one or more laser diodes and/or one or more photodetectors mounted on it directly beneath die-side lens surface 314 of lens body 310. Surface 314 allows the passing of optical signals through the lens body to and from lens surface 312 via TIR surface 318.

In one embodiment, lens body 310 includes space 316, which is an air gap formed in lens body 310. Space 316 is a cavity that allows the lens to sit over optical conversion components, such as laser diodes, photodetectors, and/or integrated circuits or controllers. In one embodiment, substrate 320 includes solder balls 322 to provide electrical connectivity from circuit 300 to a circuit on which it is mounted. Substrate 320 includes traces, vias, and other electrical properties to allow it to conduct electrical signals to and from the conversion circuits. Lens surface 312 allows circuit 300 to interface optically with other components. Thus, circuit 300 can be a standalone electrical-optical conversion component that is mountable via standard SMT processes.

In one embodiment, die-side lens surface 314 includes optical lenses to allow focusing of light toward optical components on substrate 320, and collimation of light from such optical components. Lens surfaces are used to manipulate optical beams. In one embodiment, substrate 320 includes a low power I/C to drive laser diode(s) mounted on the substrate, and/or to amplify signals from photodiode(s). As mentioned above, laser diodes convey electrical energy to photonic energy, while photodiodes or photodetectors convey photonic energy to electrical energy.

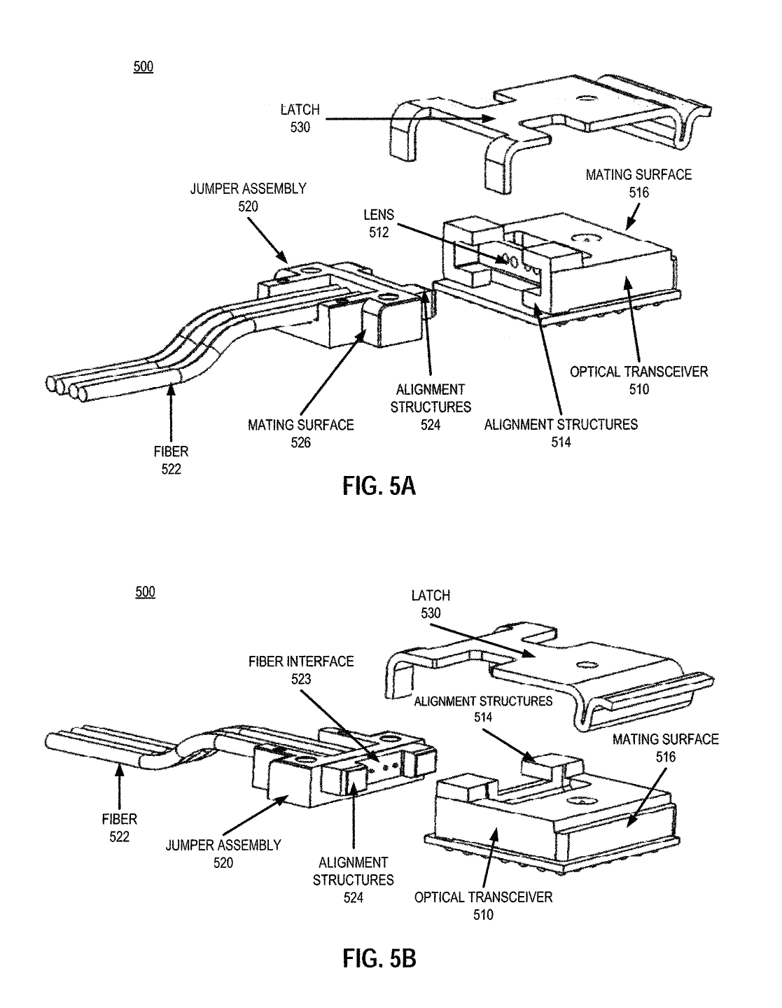

In one embodiment, substrate 320 is a BGA substrate. Substrate 320 provides mechanical support for mounting lens body 310, and any associated photonic components (e.g., laser diode, photodiode, low-power IC), as well as electrical connectivity. Solder ball 312 attached onto substrate 320 facilitates the electrical (signal, power, ground) connections. In one embodiment, lens body 310 includes flat surfaces 330 for alignment. Surfaces 330 mate and passively align a fiber connector (see FIGS. 4, 5A, and 5B below).

In operation, the IR-reflowable optical transceiver can be picked and placed onto a motherboard and then go through IR reflow with the motherboard. During the reflow process, solder ball 312 will melt onto the mounting pads at the motherboard. As a result, the entire optical transceiver can be attached onto the motherboard with standard processing.

FIG. 4 is a block diagram of an embodiment of an optical transceiver interfacing with an optical jumper connector. Assembly 400 includes optical transceiver 410 mated with jumper assembly 420. Optical transceiver 410 can be any transceiver circuit according to any embodiment described herein. In one embodiment, optical transceiver 410 provides surface-mountable electrical-optical conversion. Jumper assembly 420 includes fibers 422, which can correspond one-to-one to active lenses on optical transceiver 410. Jumper assembly 420 allows the exchange of optical signals to a point off the circuit to which optical transceiver 410 is mounted.

In one embodiment, after solder reflow, jumper assembly 420 is mechanically latched to IR-reflowable optical transceiver 410 with latch 430. Thus, the entire assembly can convey optical signals in to and out from optical transceiver 410 through optical fibers 422. In one embodiment, fibers 422 connect to an I/O port on a computing device through which the computing device connects optically to a peripheral device. In one embodiment, fibers 422 optically connect different components within a computing device.

FIGS. 5A-5B illustrate block diagrams of different perspectives of an embodiment of an optical connector that secures with a jumper connector via a latch. Referring to FIG. 5A, Optical transceiver 510 includes a plastic lens body that is able to withstand IR solder reflow. Lens 512 allows the optical transceiver to exchange optical signals with an external device. Jumper assembly 520 includes fibers 522, which interface with lenses 512 of optical transceiver 510.

In one embodiment, optical transceiver 510 includes alignment structures 514 that mate with corresponding alignment structures 524 on jumper assembly 520. The alignment structures shown could be referred to as “C-shaped” alignment features. Other alignment configurations are possible. One advantage to the C-shaped alignment features shown is the passive alignment and good securing of the components of assembly 500.

In one embodiment, mating surfaces 516 on optical transceiver 510 and 526 on jumper assembly 520 are used to mate with latch 530, which provides mechanical support to the mating optical transceiver 510 to jumper assembly 520. Thus, alignment structures 524 of jumper assembly 520 can be mated with alignment structures 514 of optical transceiver 510, and then the interfacing secured by the use of latch 530.

Referring to FIG. 5B, the same optical transceiver 510, jumper assembly 520, alignment structures 514 and 524, and latch 530 are illustrated from a different perspective. Mating surface 516 is more clearly visible in FIG. 5B. Additionally, fiber interface 523 is shown, which is the interfacing point of fibers 522 on jumper assembly 520. In one embodiment, fiber interface 523 is the end of the fiber that is mounted into a fiber channel of the jumper connector body of jumper assembly 520. In one embodiment, the jumper connector body of jumper assembly 520 includes lenses that couple the light from fiber interface 523 to the ends of the fibers.

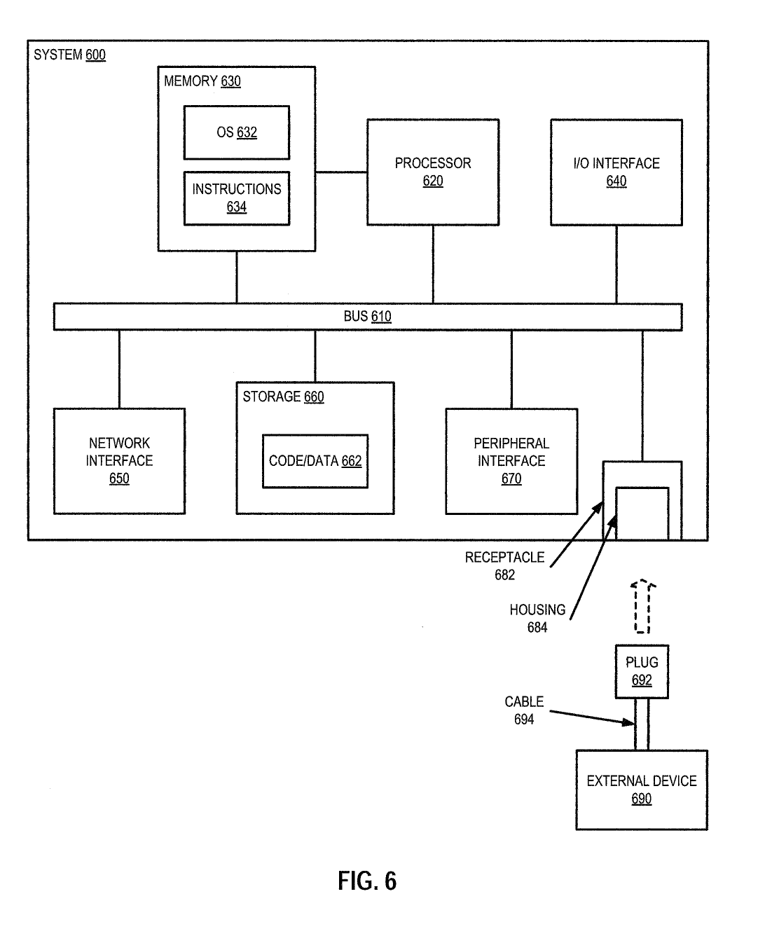

FIG. 6 is a block diagram of an embodiment of a computing system in which an optical connector can be used. System 600 represents a computing device in accordance with any embodiment described herein, and can be a laptop computer, a desktop computer, a server, a gaming or entertainment control system, a scanner, copier, printer, or other electronic device. System 600 includes processor 620, which provides processing, operation management, and execution of instructions for system 600. Processor 620 can include any type of microprocessor, central processing unit (CPU), processing core, or other processing hardware to provide processing for system 600. Processor 620 controls the overall operation of system 600, and can be include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 630 represents the main memory of system 600, and provides temporary storage for code to be executed by processor 620, or data values to be used in executing a routine. Memory 630 can include one or more memory devices such as read-only memory (ROM), flash memory, one or more varieties of random access memory (RAM), or other memory devices, or a combination of such devices. Memory 630 stores and hosts, among other things, operating system (OS) 632 to provide a software platform for execution of instructions in system 600. Additionally, other instructions 634 are stored and executed from memory 630 to provide the logic and the processing of system 600. OS 632 and instructions 634 are executed by processor 620.

Processor 620 and memory 630 are coupled to bus/bus system 610. Bus 610 is an abstraction that represents any one or more separate physical buses, communication lines/interfaces, and/or point-to-point connections, connected by appropriate bridges, adapters, and/or controllers. Therefore, bus 610 can include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (commonly referred to as “Firewire”). The buses of bus 610 can also correspond to interfaces in network interface 650.

System 600 also includes one or more input/output (I/O) interface(s) 640, network interface 650, one or more internal mass storage device(s) 660, and peripheral interface 670 coupled to bus 610. I/O interface 640 can include one or more interface components through which a user interacts with system 600 (e.g., video, audio, and/or alphanumeric interfacing). Network interface 650 provides system 600 the ability to communicate with remote devices (e.g., servers, other computing devices) over one or more networks. Network interface 650 can include an Ethernet adapter, wireless interconnection components, USB (universal serial bus), or other wired or wireless standards-based or proprietary interfaces.

Storage 660 can be or include any conventional medium for storing large amounts of data in a nonvolatile manner, such as one or more magnetic, solid state, or optical based disks, or a combination. Storage 660 hold code or instructions and data 662 in a persistent state (i.e., the value is retained despite interruption of power to system 600). Storage 660 can be generically considered to be a “memory,” although memory 630 is the executing or operating memory to provide instructions to processor 620. Whereas storage 660 is nonvolatile, memory 630 can include volatile memory (i.e., the value or state of the data is indeterminate if power is interrupted to system 600).

Peripheral interface 670 can include any hardware interface not specifically mentioned above. Peripherals refer generally to devices that connect dependently to system 600. A dependent connection is one where system 600 provides the software and/or hardware platform on which operation executes, and with which a user interacts.

In one embodiment, system 600 can include one or more receptacles 682 with housing 684 to receive plug 692 or mate with plug 692 to connect to external device 690. Receptacle 682 includes housing 684, which provides the mechanical connection mechanisms. As used herein, mating one connector with another refers to providing a mechanical connection. The mating of one connector with another typically also provides a communication connection. Receptacle 682 can connect directly to one or more buses of bus system 610, or receptacle 682 can be associated directly with one or more devices, such as network interface 650, I/O interface 640, storage 660, peripheral interface 670, or processor 620.

Plug 692 is a connector plug that allows external device 690 (which can be any of the same types of devices discussed above) to interconnect with device 600. Plug 692 can be directly built into external device 690 (with or without a cord or cable 694), or can be interconnected to external device 690 via a standalone cable 694. In one embodiment, plug 692 supports communication via an optical interface or both an optical interface and an electrical interface. The interconnection of receptacle 682 to bus 610 can similarly include an optical path or both an optical and electrical signal path. Receptacle 682 can also include an optical communication connection that is converted to an electrical signal prior to being placed on bus 610.

In one embodiment, one or more components of system 600 include an optical interface that is created by a solder-reflowable optical transceiver in accordance with any embodiment described herein. The optical components can interface with one or more other components internally to system 600, and/or with one or more external devices 690 via receptacle(s) 682. Receptacle 682 provides the hardware port through which external optical signals can be exchanged, for example, with peripheral devices.

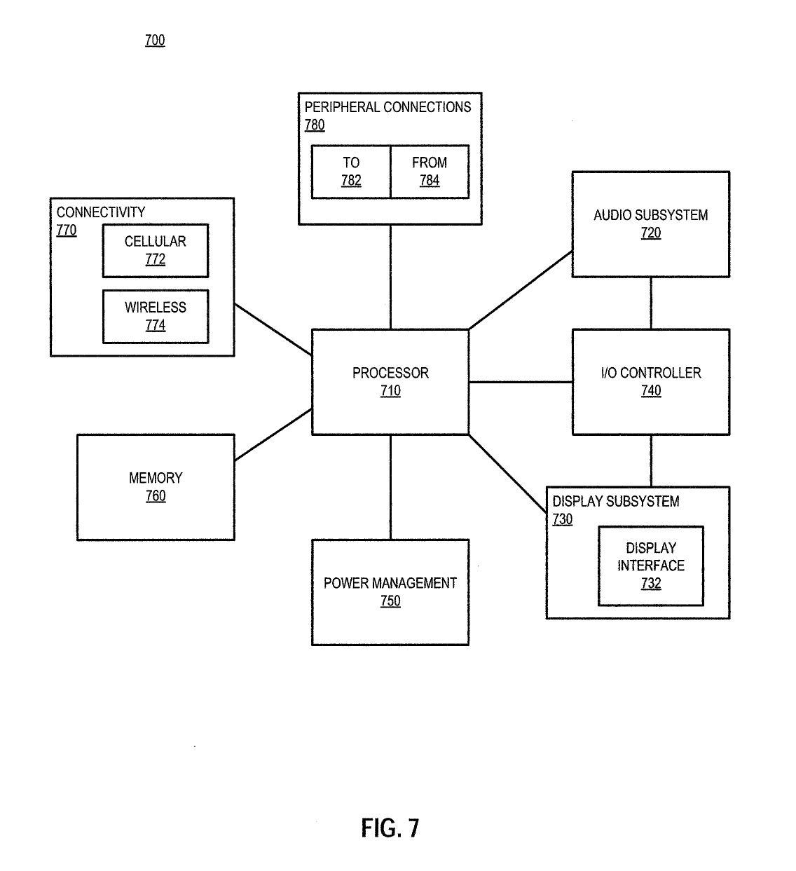

FIG. 7 is a block diagram of an embodiment of a mobile device in which an optical connector can be used. Device 700 represents a mobile computing device, such as a computing tablet, a mobile phone or smartphone, a wireless-enabled e-reader, or other mobile device. It will be understood that certain of the components are shown generally, and not all components of such a device are shown in device 700.

Device 700 includes processor 710, which performs the primary processing operations of device 700. Processor 710 can include one or more physical devices, such as microprocessors, application processors, microcontrollers, programmable logic devices, or other processing means. The processing operations performed by processor 710 include the execution of an operating platform or operating system on which applications and/or device functions are executed. The processing operations include operations related to I/O (input/output) with a human user or with other devices, operations related to power management, and/or operations related to connecting device 700 to another device. The processing operations can also include operations related to audio I/O and/or display I/O.

In one embodiment, device 700 includes audio subsystem 720, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into device 700, or connected to device 700. In one embodiment, a user interacts with device 700 by providing audio commands that are received and processed by processor 710.

Display subsystem 730 represents hardware (e.g., display devices) and software (e.g., drivers) components that provide a visual and/or tactile display for a user to interact with the computing device. Display subsystem 730 includes display interface 732, which includes the particular screen or hardware device used to provide a display to a user. In one embodiment, display interface 732 includes logic separate from processor 712 to perform at least some processing related to the display. In one embodiment, display subsystem 730 includes a touchscreen device that provides both output and input to a user.

I/O controller 740 represents hardware devices and software components related to interaction with a user. I/O controller 740 can operate to manage hardware that is part of audio subsystem 720 and/or display subsystem 730. Additionally, I/O controller 740 illustrates a connection point for additional devices that connect to device 700 through which a user might interact with the system. For example, devices that can be attached to device 700 might include microphone devices, speaker or stereo systems, video systems or other display device, keyboard or keypad devices, or other I/O devices for use with specific applications such as card readers or other devices.

As mentioned above, I/O controller 740 can interact with audio subsystem 720 and/or display subsystem 730. For example, input through a microphone or other audio device can provide input or commands for one or more applications or functions of device 700. Additionally, audio output can be provided instead of or in addition to display output. In another example, if display subsystem includes a touchscreen, the display device also acts as an input device, which can be at least partially managed by I/O controller 740. There can also be additional buttons or switches on device 700 to provide I/O functions managed by I/O controller 740.

In one embodiment, I/O controller 740 manages devices such as accelerometers, cameras, light sensors or other environmental sensors, gyroscopes, global positioning system (GPS), or other hardware that can be included in device 700. The input can be part of direct user interaction, as well as providing environmental input to the system to influence its operations (such as filtering for noise, adjusting displays for brightness detection, applying a flash for a camera, or other features).

In one embodiment, device 700 includes power management 750 that manages battery power usage, charging of the battery, and features related to power saving operation. Memory subsystem 760 includes memory devices for storing information in device 700. Memory 760 can include nonvolatile (state does not change if power to the memory device is interrupted) and/or volatile (state is indeterminate if power to the memory device is interrupted) memory devices. Memory 760 can store application data, user data, music, photos, documents, or other data, as well as system data (whether long-term or temporary) related to the execution of the applications and functions of system 700.

Connectivity 770 includes hardware devices (e.g., wireless and/or wired connectors and communication hardware) and software components (e.g., drivers, protocol stacks) to enable device 700 to communicate with external devices. The device could be separate devices, such as other computing devices, wireless access points or base stations, as well as peripherals such as headsets, printers, or other devices.

Connectivity 770 can include multiple different types of connectivity. To generalize, device 700 is illustrated with cellular connectivity 772 and wireless connectivity 774. Cellular connectivity 772 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, LTE (long term evolution—also referred to as “4G”), or other cellular service standards. Wireless connectivity 774 refers to wireless connectivity that is not cellular, and can include personal area networks (such as Bluetooth), local area networks (such as WiFi), and/or wide area networks (such as WiMax), or other wireless communication. Wireless communication refers to transfer of data through the use of modulated electromagnetic radiation through a non-solid medium. Wired communication (including optical communication) occurs through a solid communication medium.

Peripheral connections 780 include hardware interfaces and connectors, as well as software components (e.g., drivers, protocol stacks) to make peripheral connections. It will be understood that device 700 could both be a peripheral device (“to” 782) to other computing devices, as well as have peripheral devices (“from” 784) connected to it. Device 700 commonly has a “docking” connector to connect to other computing devices for purposes such as managing (e.g., downloading and/or uploading, changing, synchronizing) content on device 700. Additionally, a docking connector can allow device 700 to connect to certain peripherals that allow device 700 to control content output, for example, to audiovisual or other systems.

In addition to a proprietary docking connector or other proprietary connection hardware, device 700 can make peripheral connections 780 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other type.

Any of the interconnections or I/O can be performed optically. Thus, I/O controller 740, display subsystem 730, memory 760, connectivity 770, and/or peripheral connections 780 can have an optical connection with processor 710 or with an external component. In the case of an optical connection, the optical connection can be accomplished through an optical connector or with an optical transceiver in accordance with any embodiment described herein. The optical transceiver includes a plastic lens body that can withstand the environment of solder reflow without deformation that would negatively affect its ability to provide optical signaling.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. An optical connector comprising:
a substrate to electrically connect to a circuit;
an optical lens body disposed on the substrate to exchange optical signals through lenses on the lens body, the lens body formed of a plastic having a CTE (coefficient of thermal expansion) sufficient to withstand warping during solder reflow processing.

2. The optical connector of claim 1, wherein the substrate is to connect electrically to the circuit via a solder connection.

3. The optical connector of claim 2, wherein the substrate has a ball-grid array (BGA) to electrically connect to the circuit.

4. The optical connector of claim 2, wherein the substrate has a land-grid array (LGA) to electrically connect to the circuit.

5. The optical connector of claim 2, wherein the substrate is to connect to a printed circuit board (PCB).

6. The optical connector of claim 1, wherein the substrate is to connect to an integrated circuit.

7. The optical connector of claim 1, wherein the substrate further comprises at least one laser diode and at least one photodetector disposed on the substrate, and wherein the lens body is disposed on the substrate over the laser diode and photodetector to optically align one lens for each laser diode and photodetector.

8. The optical connector of claim 7, wherein the lens body further comprises a total internal reflection (TIR) surface to redirect the optical signals at approximately a right angle between the lenses and the laser diode and photodetector.

9. The optical connector of claim 1, wherein the lens body further comprises mating structures to interface to a jumper connector that has optical fibers to exchange signals with the lenses.

10. The optical connector of claim 9, further comprising:
a latch to secure the jumper connector to the lens body.

11. A system comprising:
a hardware port over which to exchange optical signals with a computer peripheral device;
an optical connector to interface a circuit to optical fibers that connect to the hardware port, the optical connector including
a substrate to electrically connect to the circuit;
an optical lens body disposed on the substrate to exchange optical signals through lenses on the lens body with the optical fibers, the lens body formed of a plastic having a CTE (coefficient of thermal expansion) sufficient to withstand warping during solder reflow processing; and
a jumper connector to interface and align the optical fibers with the lens body.

12. The system of claim 11, wherein the substrate is to connect electrically to the circuit via a solder connection.

13. The system of claim 12, wherein the substrate has either a ball-grid array (BGA) or a land-grid array (LGA) to electrically connect to the circuit.

14. The system of claim 12, wherein the substrate is to connect to a printed circuit board (PCB).

15. The system of claim 14, wherein the PCB is a circuit printed on an FR4 (flame-retardant 4) PCB substrate.

16. The system of claim 11, wherein the substrate further comprises at least one laser diode and at least one photodetector disposed on the substrate, and wherein the lens body is disposed on the substrate over the laser diode and photodetector to optically align one lens for each laser diode and photodetector.

17. The system of claim 16, wherein the lens body further comprises a total internal reflection (TIR) surface to redirect the optical signals at approximately a right angle between the lenses and the laser diode and photodetector.

18. The system of claim 11, further comprising:
a latch to secure the jumper connector to the lens body.

19. The system of claim 11, wherein the system is a tablet computer device.
